(19) United States
(12) Patent Application Publication
(10) Pub. No.: US 2007/0157513 A1
(43) Pub. Date: Jul. 12, 2007

(54) Plant potting

(76) Inventors: James R. Varney, Belmont, MA (US); Bryan R. Hotaling, Harvard, MA (US)

Correspondence Address: FISH & RICHARDSON PC, P.O. BOX 1022, MINNEAPOLIS, MN, 55440-1022, US

(21) Appl. No.: 11/328,856

(22) Filed: Jan. 10, 2006

(51) Int. Cl. A01G 9/02; A01G 9/04

(52) U.S. Cl. 47/65.8; 47/71

(57) ABSTRACT

A plant pot includes a sleeve and a base disposed across one end of the sleeve, the sleeve and base together forming a container for holding potting soil. The sleeve is formed of a flexible membrane that is both permeable to air and water vapor, and impermeable to liquid water, enabling aeration of the soil through the sleeve while inhibiting liquid water transfer across the fabric.

### TECHNICAL FIELD

This invention relates to plant potting, and more particularly to collapsible planting containers.

### BACKGROUND

Freestanding plant pots are most commonly available in two material types; ceramic and plastic. Non-glazed ceramics, like terra cotta, provide a breathable and porous barrier between the potting medium (soil) and the air, allowing proper aeration of the plant's roots and ultimately a healthier plant. However, this porosity also allows water to be absorbed into the walls of the pot and evaporate out, drying the soil faster than a plastic pot and leaving behind harmful soluble salts that normally would be flushed out when the plant is watered. Plastic pots tend to be light weight and non-breakable, yet their non-porous walls do not allow for root aeration, and both types take up a large amount of space for the retailer, even when nested and stacked. In short, there is no ideal freestanding design available on the market that gives the plant everything it needs, while at the same time provides retailers with a compact, lightweight product.

### SUMMARY

Various aspects of this invention feature plant pots with side walls at least partially formed of an air-breathable, waterproof material, such as a flexible fabric with such characteristics.

According to one aspect of the invention, a plant pot includes a sleeve and a base disposed across one end of the sleeve, the sleeve and base together forming a container for holding potting soil, wherein the sleeve comprises a flexible membrane that is both permeable to air and water vapor, and impermeable to liquid water.

In many preferred embodiments, the sleeve is supportable in an upright position by potting soil held within the sleeve, but in an absence of soil is collapsible toward the base for storage. Preferably, the sleeve is free of vertical support structure other than any contained soil.

The membrane preferably has a Moisture Vapor Transfer Rate of at least 200 grams per square meter per day, more preferably at least 500 grams per square meter per day, and a Suter Test result of at least about 50 cm, more preferably at least about 100 cm.

In some embodiments the membrane comprises a flexible fabric, and in some cases the sleeve consists essentially of the membrane, such as with the membrane folded at an open end of the sleeve to define a thickened rim.

For some applications the membrane is continuous about the sleeve.

In some embodiments the sleeve includes a releasable fastener, such as a zipper, that is manually operable to open a side of the sleeve for removal of a contained root ball. In some cases the sleeve includes an extension web behind the fastener, such that opening the side of the sleeve forms a side wall opening with the extension web extending across the side wall opening.

The sleeve, in some configurations, is removably attached to the base. For example, some sleeves have loops that releasably engage hook features of the base.

In some cases the sleeve is tapered to be narrower at an open end thereof than at a point between the open end and the base. The sleeve may be frusto-conical in shape, for example, or may taper inward toward each end of the sleeve, with a wider middle portion.

Preferably the base is formed to be more rigid than the sleeve, and may be formed of molded resin, for example.

In some embodiments the base defines an internal water reservoir. In some cases the base has an upper surface defining apertures that provide hydraulic communication between the water reservoir and a planting volume defined within the sleeve. For some applications the base defines vent holes providing hydraulic communication between the reservoir and atmosphere, for evaporation transport. Such vent holes may be spaced above a lower extent of the water reservoir to define a maximum reservoir water level.

According to another aspect of the invention, a plant pot includes a sleeve and a base disposed across one end of the sleeve, the sleeve and base together forming a container for holding potting soil, wherein the sleeve comprises a flexible membrane and defines an opening opposite the base and narrower than a lateral width of the sleeve at a point between the opening and the base, by potting soil held within the sleeve, such that the sleeve is supportable in an upright position by filling the sleeve with soil, but in an absence of soil is collapsible toward the base for storage.

The membrane preferably comprises an air-breathable, waterproof material, such as a flexible fabric with such characteristics.

A third aspect of the invention features a plant pot having a sleeve and a base disposed across one end of the sleeve, the sleeve and base together forming a container for holding potting soil, wherein the sleeve comprises a flexible membrane that is supportable in an upright position by potting soil held within the sleeve, but in an absence of soil is collapsible toward the base for storage, and in which the base defines an internal water reservoir positioned to collect water drained from within the sleeve.

The membrane preferably comprises an air-breathable, waterproof material, such as a flexible fabric with such characteristics.

The other specific, optional features described above with respect to the first aspect of the invention are also optional with respect to the second and third aspects of the invention.

A fourth aspect of the invention features a method of supporting and transporting a quantity of potting soil containing living plant roots, by placing potting soil in one of the above-described pots, and supporting the potting soil against the flexible membrane, enabling air to permeate from surrounding atmosphere directly into the soil through the membrane.

In various embodiments, the pot is freestanding when filled, but collapsible when empty by virtue of the flexible fabric wall, making for a very lightweight and compact single unit (in fact, multiple pots could be stored in the same volume of space as one rigid terra cotta or plastic walled pot). The micro-porous fabric preferably has tiny holes that allow air molecules to pass through, yet are too small for water droplets. Suitable materials are readily available in the field of waterproof outdoor equipment, such as jackets and tents. It is the waterproof yet gas-permeable nature of this material which allows the pot to aerate the plant roots and at the same time prevents the accumulation of harmful salts. In many embodiments, the fabric walls do not need any other vertical structure since the shape of the pot itself (slightly wider at the base or in the middle than at the top) creates a captured volume of soil when filled. In this case, the force of gravity downward on the soil actually reinforces the upright shape of the pot. The inside bottom surface of the pot is preferably water permeable, either through a fabric mesh or perforations in a plastic drip tray, allowing proper drainage. The drip tray can form an enclosed volume attached to the bottom edge of the fabric walls with several holes in its top surface, for example. These holes allow water to drain from the soil and then evaporate out into the surrounding air. The fabric pot may also incorporate a watertight zipper along its height so as to allow removal of the potting medium and root ball for repotting purposes.

Furthermore, use of woven fabric allows these plant pots to be created in a wide variety of shapes, colors and patterns that give users the ability to customize and match their decor without using separate pot covers and sleeves. This aesthetic design flexibility, combined with the above performance characteristics, creates a product that benefits both the user and their plant. Plus, merchants will appreciate that the collapsibility of the empty pot structure makes it cheaper to ship, saves space on shelves, and opens up display options unavailable to traditional pots.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a pot containing a plant.

FIG. 2 is a vertical cross-section view of the pot of FIG. 1, showing the soil and no plant.

FIG. 3 illustrates removal of the soil and plant from the pot of FIG. 1.

FIG. 4 shows the pot of FIG. 1 in a collapsed state following plant removal, for storage.

FIG. 5 is a perspective view of a fabric sleeve of a second plant pot embodiment.

FIG. 6 shows the sleeve of FIG. 5 being joined to a rigid plastic base.

FIG. 7 is a bottom perspective view of the joined sleeve and base.

FIG. 8 is a perspective view of a third plant pot, having a barreled sleeve shape.

FIG. 9 is a vertical cross-sectional view of the pot of FIG. 8.

FIG. 10 is a perspective view of a plant pot with flexible handles.

FIG. 11 is a perspective view of a plant pot with a rigid rim.

FIG. 12 is a perspective view of a plant pot consisting essentially of a breathable sleeve and a mesh bottom for water drainage.

FIG. 13 is a perspective view of a plant pot with an integral wire spring that supports the sleeve but is collapsible for storage.

FIG. 14 is a perspective view of a plant pot in the form of a flexible membrane supported from its upper rim on a frame.

FIG. 15 illustrates joining multiple plant pot bases.

Like reference symbols in the various drawings indicate like elements.

### DETAILED DESCRIPTION

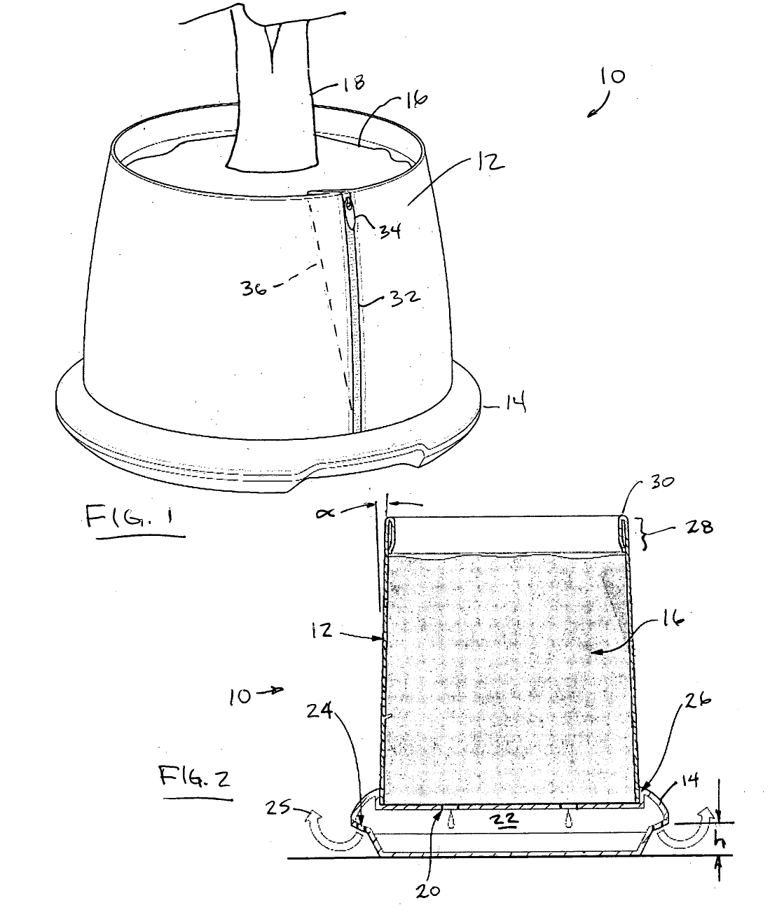

Referring first to FIG. 1, a plant pot 10 consists essentially of a flexible fabric sleeve 12 supported on a rigid plastic base 14. The sleeve is shown filled with a planting soil 16 containing a root ball of a plant 18.

FIG. 2 shows a cross-section of the pot 10 without the plant. As shown in this view, fabric sleeve 12 is shaped so as to have a slight taper, narrowing from bottom to top, forming a taper angle α of about one degree with the vertical. The soil 16 in the sleeve keeps the sleeve in its extended, upright condition as shown. The fabric of sleeve 12 is a material that allows air to pass through the material from the environment into the soil for aeration of the soil and roots, and allows evaporation of moisture in the form of water vapor from the soil through the material while preventing liquid moisture from passing through the material. Water from surface irrigation is drained from the soil through small drainage holes 20 in the upper surface of base 14, into a water reservoir 22 defined within the plastic base. From the reservoir the water evaporates into the surrounding atmosphere through downwardly-facing vent holes 24 arranged about the sides of the base, as illustrated by arrows 25. The height ‘h’ of vent holes 24 establishes a maximum reservoir fill level.

The lower end of sleeve 12 is secured about its circumference to the upper portion of base 14, either permanently such as by adhesive or mechanical fasteners, or removably. In this embodiment, a lip 26 extends upward around the lower edge of sleeve 12 for lateral support and, in some cases, to facilitate sleeve fastening. The upper rim of sleeve 12 is formed by a folded region 28 of the fabric material. This sleeve cuff is created by folding inward the distal edge of the sleeve material and securing it to the inside surface of the sleeve. This avoids an exposed material edge and provides the sleeve with a smooth, reinforced rim 30. Otherwise, sleeve 12 is seamless about its periphery.

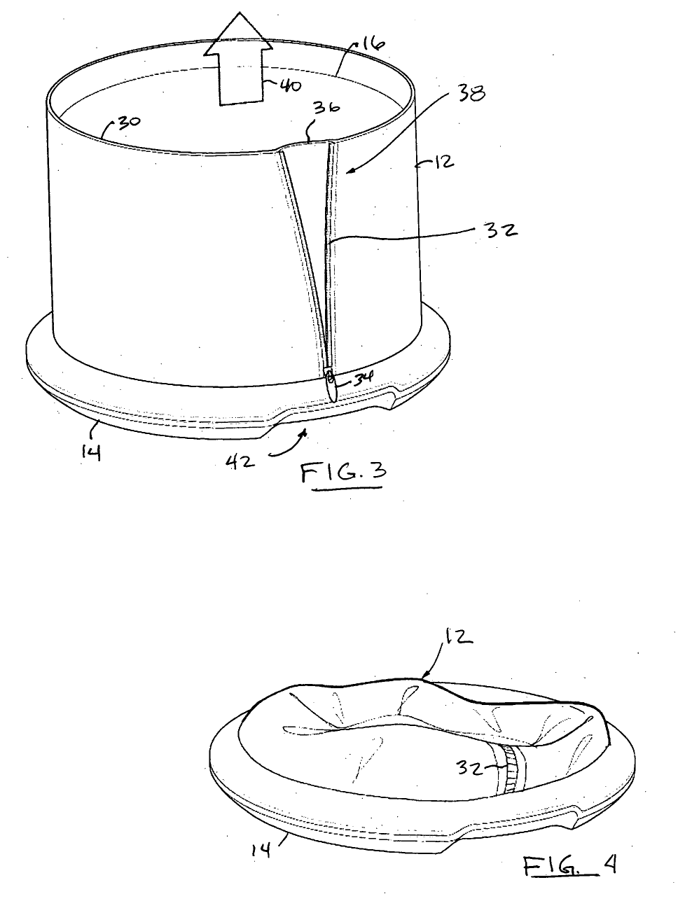

Referring to FIG. 3, pot 10 is provided with a zipper 32 extending up the side of the sleeve from near the base. Zipper 32 is opened by pulling downward on zipper pull 34, allowing sleeve gusset 36 to expand to form a wedge-shaped sleeve expansion zone 38, thereby expanding the rim diameter to facilitate root ball removal. Gusset 36 is preferably dimensioned so as to allow the upper rim diameter of the sleeve to be opened to at least the widest diameter of the sleeve. With zipper 32 opened as shown, the soil containing the root ball can be more readily removed upward as a single mass as indicated by arrow 40. Molded depressions on opposite sides of the base form hand-holds 42 for carrying the filled pot.

With the plant and soil removed, the sleeve is readily collapsible (and in this embodiment, collapses under its own weight) for storage, as shown in FIG. 4. The base 14 may be so dimensioned that the sleeve 12 is fully collapsible to within the volume bounded by the upper rim of the base, for example. As collapsed, the pot is easily stackable, transportable and storable in a relatively small volume.

For breathability, it is preferred that the fabric of sleeve 12 have a Moisture Vapor Transfer Rate (MVTR) of at least 200 g/m²/24 hrs (grams per square meter per day), as measured in accordance with ASTM E96, upright cup method, more preferably at least 500 g/m²/24 hrs. For liquid water impermeability, the fabric preferably has a Suter hydrostatic resistance of at least about 50 cm, as measured in accordance with ASTM D751, Suter test method (roughly equivalent to a Mullen rating of about 0.5 pound per square inch), more preferably at least about 100 cm.

An example of an acceptable fabric is Crypton® brand Super Fabrics “Bonnie” pattern, as available through Architex International®, 3333 Commercial Avenue, Northbrook, Ill. 60062, available online at www.architex-ljh.com.

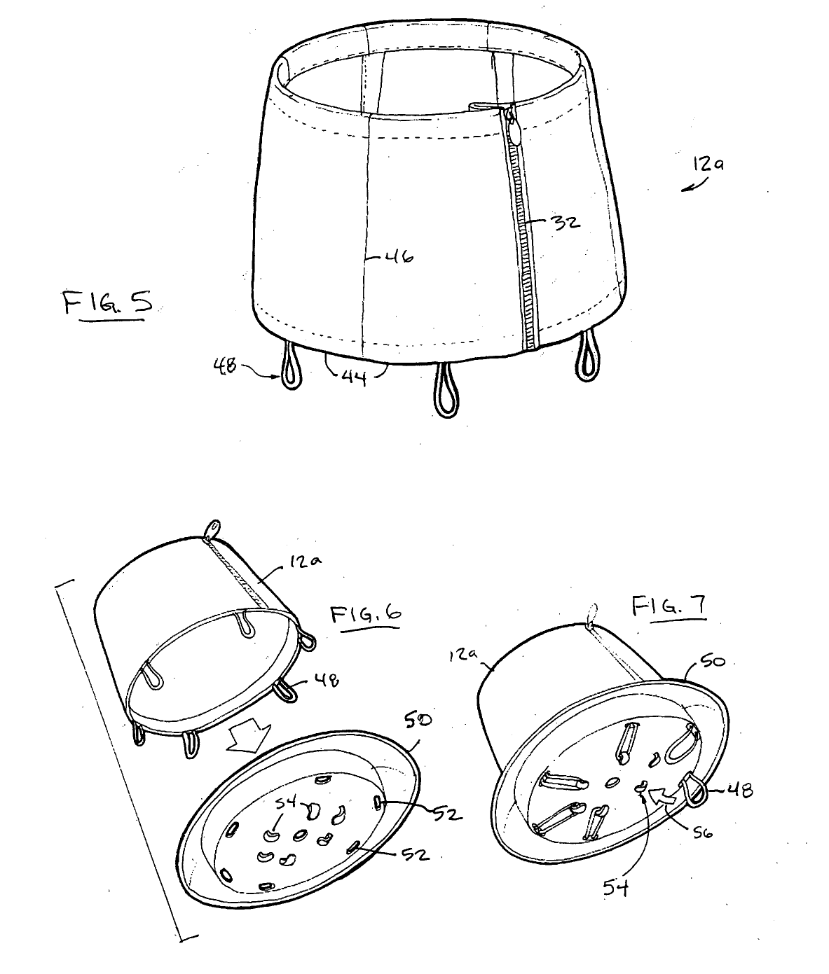

FIG. 5 shows another sleeve construction. Sleeve 12a is of the same general tapered cylindrical shape as the sleeve described above, but is formed by sewing together multiple fabric segments 44 along vertical stitch lines 46. An elastic loop 48 is sewn onto the lower end of each segment. As shown in FIG. 6, sleeve 12a is releasably secured to an upper half 50 of a base by passing loops 48 through holes 52 and stretching them over loop hooks 54 integrally molded with the underside of base upper half 50, as illustrated by arrow 56 in FIG. 7. Holes 52 also serve as drain holes.

Other sleeve shapes are also envisioned. For example, FIGS. 8 and 9 show a plant pot with a sleeve 12b shaped to have its greatest diameter at a hipline 58 between the rim 30 and base 14. The sleeve diameter is progressively larger moving from base to hipline, and then progressively smaller from hipline to rim. Therefore, zipper 32 and its associated gusset need only extend from rim 30 to hipline 58 to effect sleeve opening for root ball extraction. The inverse tapered upper portion of the sleeve, from hipline to rim, is sufficient for the soil load on the inner surface of the sleeve to maintain the sleeve in its erect position as shown. In this example, the inverse tapered upper portion forms approximately the upper third of the exposed sleeve, and forms a taper angle α of about 10 degrees with respect to vertical, while the lower tapered portion of the sleeve forms a reverse taper angle β of about 10 degrees with respect to vertical.

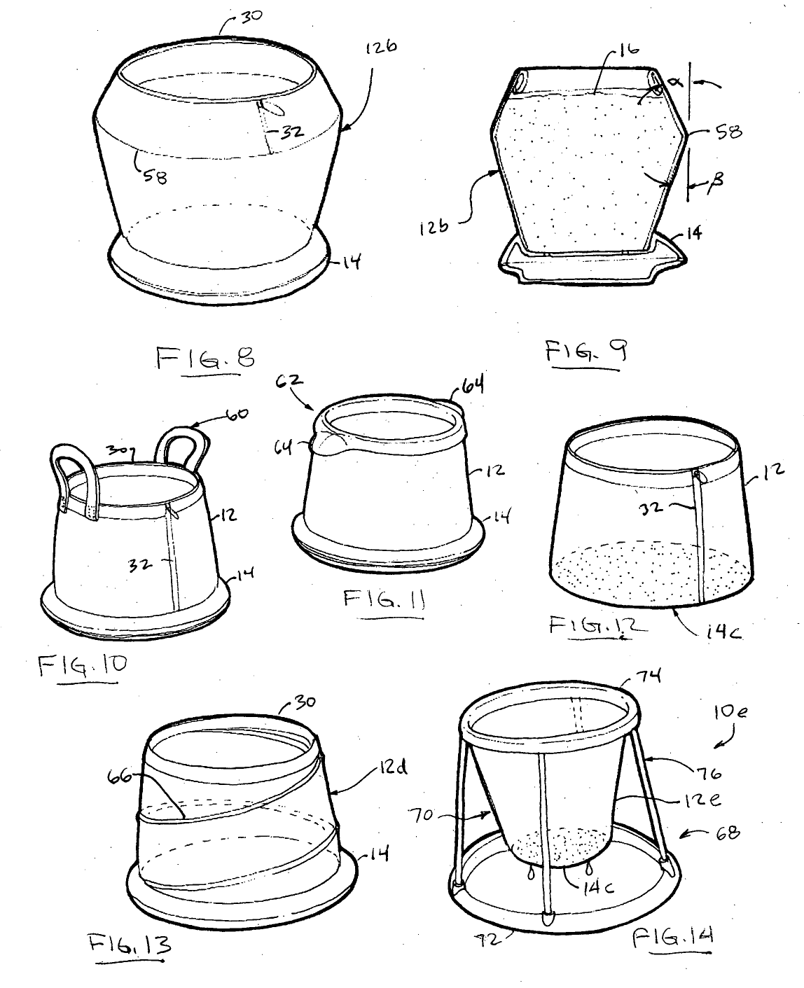

Other constructions of the rim of the pot are also envisioned. For example, FIG. 10 shows a pot with flexible handles 60 sewn to opposite sides of the sleeve cuff, for carrying the filled pot. In the pot of FIG. 11, a molded plastic rim 62 is secured to the upper end of sleeve 12, providing a fixed, rigid opening for the pot and molded grips 64 at the upper end of the pot. It will be appreciated that removal of the enclosed soil from the pot of FIG. 11 requires more disturbance of the outer soil regions than in the previously described pots, due to the non-opening nature of rim 62. However, the sleeve of the pot of FIG. 11 may be releasably secured to its base, such as by the means shown in FIGS. 5-7, such that the sleeve may be withdrawn from over the soil for some applications.

FIG. 12 illustrates a pot consisting essentially of breathable sleeve 12 and a base 14c in the form of a mesh extending across the bottom end of the sleeve. The mesh provides the necessary water drainage from the soil through the holes defined through the mesh. The mesh may be rigid or flexible, and provides no reservoir for the collection of drained water. Mesh base 14c may be secured across the lower sleeve end by sewing, for example.

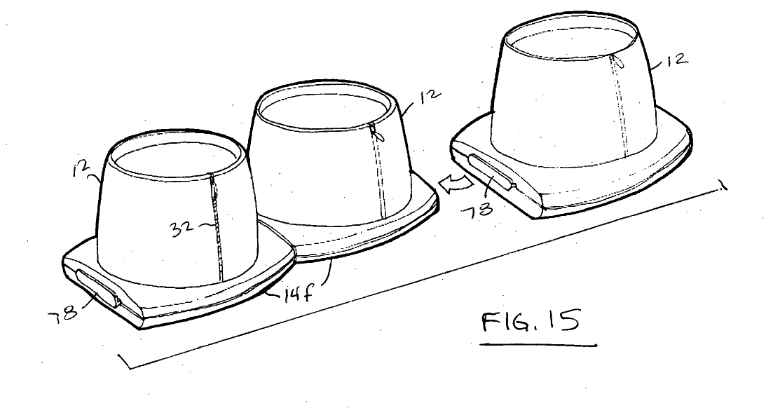

In the above-described pots the sleeves have all been of a structure incapable of maintaining itself in an upright condition in the absence of enclosed soil or other load bearing material. Rather, in each of the above examples, the sleeve of the empty pot collapses under its own weight. In the pot of FIG. 13, a spiral spring 66 is sewn into sleeve 12d and biases the sleeve toward its extended state as shown, even in the absence of enclosed soil, while still enabling the sleeve to be collapsed for storage and shipment when empty. Due to the effect of spring 66, sleeve 12d may be fashioned to have a non-tapering, cylindrical shape, or even tapered such that the sleeve diameter increases from base 14 to rim 30, because soil load is not required to maintain pot shape.

FIG. 14 shows a pot 10e with a frame 68 supporting a plant-carrying container 70 from its upper rim. Frame 68 includes a base 72, a rigid circular rim member 74 secured to the upper edge of the container, and four rigid columns 76 interconnecting the frame base and rim member to bear the weight of the plant container. Container 70 consists essentially 10 of a tapered sleeve 12e of air-breathable, liquid water impermeable fabric, and a mesh fabric base 14c as discussed above with respect to FIG. 12. When the pot is empty, frame 68 may be broken down into its respective pieces for transport or storage, and container 70 collapsed.

The bases or frames of the above-described pots may be configured to also perform other functions. For example, the pots of FIG. 15 have four-sided bases 14f that are equipped with molded, interlocking connectors 78 that enable the bases to be releasably connected to form a chain of plant pots, such as for use in a nursery. For applications in which bottom irrigation is desirable, the bases may be provided with interconnections that provide hydraulic conductivity between adjacent bases, and wicking members that extend upward from their reservoirs into the contained soil, for simultaneously irrigation an entire chain or array of pots.

A number of embodiments of the invention have been described. Nevertheless, it will be understood that various modifications may be made without departing from the spirit and scope of the invention. Accordingly, other embodiments are within the scope of the following claims.

What is claimed is:

1. A plant pot comprising
a sleeve; and
a base disposed across one end of the sleeve, the sleeve and base together forming a container for holding potting soil,
wherein the sleeve comprises a flexible membrane that is both permeable to air and water vapor, and impermeable to liquid water.

2. The plant pot of claim 1, wherein the sleeve is supportable in an upright position by potting soil held within the sleeve, but in an absence of soil is collapsible toward the base for storage.

3. The plant pot of claim 1, wherein the sleeve is free of vertical support structure other than any contained soil.

4. The plant pot of claim 1, wherein the membrane has a Moisture Vapor Transfer Rate of at least 200 grams per square meter per day.

5. The plant pot of claim 1, wherein the membrane has a Suter Test result of at least about 50 centimeters.

6. The plant pot of claim 1, wherein the membrane comprises a flexible fabric.

7. The plant pot of claim 1, wherein the sleeve consists essentially of the membrane.

8. The plant pot of claim 7, wherein the membrane is folded at an open end of the sleeve to define a thickened rim.

9. The plant pot of claim 1, wherein the sleeve includes a releasable fastener that is manually operable to open a side of the sleeve for removal of a contained root ball.

10. The plant pot of claim 9, wherein the fastener comprises a zipper.

11. The plant pot of claim 9, wherein the sleeve includes an extension web behind the fastener, such that opening the side of the sleeve forms a side wall opening with the extension web extending across the side wall opening.

12. The plant pot of claim 1, wherein the sleeve is removably attached to the base.

13. The plant pot of claim 1, wherein the sleeve is tapered to be narrower at an open end thereof than at a point between the open end and the base.

14. The plant pot of claim 1, wherein the base defines an internal water reservoir therein.

15. The plant pot of claim 14, wherein the base has an upper surface defining apertures therethrough, the apertures providing hydraulic communication between the water reservoir and a planting volume defined within the sleeve.

16. The plant pot of claim 14, wherein the base defines vent holes providing hydraulic communication between the reservoir and atmosphere, for evaporation transport.

17. A plant pot comprising
a sleeve; and
a base disposed across one end of the sleeve, the sleeve and base together forming a container for holding potting soil,
wherein the sleeve comprises a flexible membrane and defines an opening opposite the base and narrower than a lateral width of the sleeve at a point between the opening and the base, by potting soil held within the sleeve, such that the sleeve is supportable in an upright position by filling the sleeve with soil, but in an absence of soil is collapsible toward the base for storage.

18. The plant pot of claim 17, wherein the membrane comprises an air-breathable, waterproof material.

19. The plant pot of claim 17, wherein the membrane extends to a frusto-conical shape in its upright position.

20. The plant pot of claim 17, wherein the sleeve includes a releasable fastener that is manually operable to open a side of the sleeve for removal of a contained root ball.

21. The plant pot of claim 17, wherein the base defines an internal water reservoir therein.

22. A plant pot comprising
a sleeve; and
a base disposed across one end of the sleeve, the sleeve and base together forming a container for holding potting soil,
wherein the sleeve comprises a flexible membrane that is supportable in an upright position by potting soil held within the sleeve, but in an absence of soil is collapsible toward the base for storage, and
wherein the base defines an internal water reservoir therein, the reservoir positioned to collect water drained from within the sleeve.

23. The plant pot of claim 22, wherein the sleeve defines an opening opposite the base and narrower than a lateral width of the sleeve at a point between the opening and the base, by potting soil held within the sleeve.

24. The plant pot of claim 22, wherein the membrane comprises an air-breathable, waterproof material.

25. The plant pot of claim 22, wherein the membrane extends to a frusto-conical shape in its upright position.

26. The plant pot of claim 22, wherein the sleeve includes a releasable fastener that is manually operable to open a side of the sleeve for removal of a contained root ball.

27. A method of supporting and transporting a quantity of potting soil containing living plant roots, the method comprising
placing potting soil in a pot comprising
a sleeve comprising a flexible membrane that is both permeable to air and water vapor, and impermeable to liquid water; and
a base disposed across one end of the sleeve, the sleeve and base together forming a container for holding potting soil; and
supporting the potting soil against the flexible membrane, enabling air to permeate from surrounding atmosphere directly into the soil through the membrane.
